(19) United States
(12) Patent Application Publication
(10) Pub. No.: US 2010/0061672 A1
(43) Pub. Date: Mar. 11, 2010

(54) BEARING ASSEMBLY

(75) Inventors: Timur Dizlek, Schweinfurt (DE); Josef Zylla, Schonungen (DE); Arnd Heeg, Lehrte (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/525,368

(22) PCT Filed: Nov. 17, 2007
(86) PCT No.: PCT/DE07/02083

§ 371 Date: Nov. 4, 2009

(30) Foreign Application Priority Data
Feb. 1, 2007 (DE) 10 2007 004 998.8
Sep. 18, 2007 (DE) PCT/DE2007/1685

(51) Int. Cl. F16C 33/60; F16C 19/54

(52) U.S. Cl. 384/505; 384/452

(57) ABSTRACT

A bearing assembly for a shaft or similar that is axially guided with precision in a housing. The shaft is stressed to differing degrees and/or for different periods of time in the two axial directions. The bearing assembly has a single-row angular contact ball bearing and a single-row cylindrical roller bearing. The angular contact ball bearing is designed to receive the greater main axial load that is exerted during operation, whilst the smaller axial force that acts in opposition is absorbed by the cylindrical roller bearing in addition to the radial forces. The quantity of equipment required to absorb the small axial force that in general is only exerted periodically can be kept to a minimum. In addition, a predefined axial play is pre-set in the unit and a defined lateral ring overhang is set between the inner and outer ring.

### FIELD OF THE INVENTION

The invention relates to a bearing assembly for a shaft or the like which is to be axially guided with precision in a component and which is stressed to differing degrees and/or for different time periods, comprising an angular contact ball bearing arrangement designed substantially to receive axial forces and a cylindrical roller bearing arrangement designed substantially to receive radial forces.

### BACKGROUND OF THE INVENTION

The terms “component” on the one hand and “shaft or the like” on the other are to be understood in the broadest sense to include all assemblies in which one component is mounted rotatably with respect to another component. Shafts or hubs of fan wheels or transmission shafts mounted rotatably in a housing may be mentioned as examples. Bearing assemblies, which have to absorb both axial forces and radial forces, are in many cases implemented as bearing sets with separate bearing arrangements for receiving the axial forces on the one hand and the radial forces on the other. With units of the above-mentioned type, relatively large axial forces are frequently exerted in one direction of action in operation while generally smaller axial forces are exerted only occasionally in the opposite direction of action, for example when the unit is starting or stopping.

Already known from DE 103 57 109 A1 is a bearing assembly in which an angular contact ball bearing arrangement is provided to receive axial forces and a cylindrical roller bearing arrangement is provided to receive radial forces. The angular contact ball bearing arrangement is in the form of a so-called four-point bearing, which can and must absorb axial forces in both axial directions. The angular contact ball bearing arrangement on the one hand and the cylindrical roller bearing arrangement on the other are separated from one another constructionally in such a manner that the former absorbs only axial forces while the latter absorbs only radial forces.

A general disadvantage of four-point bearings is seen to lie in the fact that these are available as standard only with a pressure angle of approximately 35°, so that, in the case of an axial force acting on the bearing, a comparatively large radial force component is exerted, which only increases the rolling friction forces of the bearing, and therefore also the wear thereon, without contributing to efficiency. Furthermore, four-point bearings are comparatively expensive.

It is also known to use a pair of angular contact ball bearings in an X-arrangement or O-arrangement as angular contact ball bearing assemblies designed to absorb axial forces. Because of the use of two angular contact ball bearings, such an assembly is also comparatively complex and costly, and additionally entails a relatively great overall axial length of the bearing.

Common to both known bearing assemblies is the fact that the quantity of equipment required to absorb a force which generally acts only periodically and is of relatively small magnitude is just as great as that required to absorb the actual main operating force.

### OBJECT OF THE INVENTION

It is the object of the invention to provide a bearing assembly of the type mentioned in the preamble of claim 1 which is inexpensive to produce, has a relatively short overall length and is better adapted than the known bearing assemblies to the special operating conditions in which, in addition to the main operating force acting in an axial direction, an oppositely directed axial force is exerted which in general is relatively small in duration and in magnitude.

### SUMMARY OF THE INVENTION

The invention is based on realization of the fact that the characteristic of cylindrical roller bearings, of also being able to absorb axial forces up to a certain degree, can be utilized to absorb the back-pressure forces, which are relatively small in duration and magnitude, so that the angular contact ball bearing arrangement can be relieved of or liberated from this task.

The invention therefore sets out from a bearing assembly for a shaft or the like which is to be axially guided with precision in a component and which is stressed to differing degrees in both axial directions, comprising an angular contact ball bearing arrangement designed substantially to receive axial forces and a cylindrical roller bearing arrangement designed substantially to receive radial forces. It is provided according to the invention, that the angular contact ball bearing arrangement is in the form of a single-row angular contact bearing designed to receive the stronger axial main operating force, and that the cylindrical roller bearing arrangement is in the form of a single-row cylindrical roller bearing conceived as a support bearing and designed to receive the weaker axial back-pressure force and the radial force.

To absorb the main operating force, therefore, a single-row angular contact ball bearing is sufficient. Such angular contact ball bearings are standard, low-cost machine elements which are available in various configurations. The back-pressure forces, which are smaller in duration and magnitude, can be absorbed without difficulty by a suitably modified cylindrical roller bearing; although the modification entails a slight increase in the constructional complexity and cost of the cylindrical roller bearing, this is more than compensated by the simplification of the angular contact ball bearing arrangement.

According to a preferred configuration of the invention, one of the two bearing rings, namely the radially outer or the radially inner ring, is formed in one piece and is fixed in both axial directions with respect to the associated component. It can therefore transmit to the associated component both the main axial operating force applied via the angular contact ball bearing and the axial back-pressure force applied via the cylindrical roller bearing. The respective other bearing ring is preferably formed from two individual rings, each of which is fixed with respect to the associated component (shaft) in a direction corresponding to the axial force to be transmitted.

A further preferred variant of the invention includes a defined axial annular overhang on one side between the inner and outer rings, preferably on the angular contact ball bearing, which makes possible a defined axial position of the shaft relative to the housing.

In a first embodiment of the bearing assembly according to the invention the radially outer bearing ring has a one-piece configuration while the inner bearing ring consists of two individual rings. According to another variant it may be provided that the inner bearing ring is in one piece and the outer bearing ring consists of two individual rings. Another development may provide that the outer or inner bearing ring consists of two individual rings firmly connected to one another, in which case these two individual rings may each have in the region of their end faces oriented towards one another an annular groove into which is fitted a clip which connects the two individual rings firmly and with flush faces without axial play.

A further configuration provides a one-piece inner ring with a separate washer disk. The two other bearing rings are also in the form of individual rings and abut one another axially at the joint B. These different variants will be described in more detail in the following explanation of exemplary embodiments.

In order that the angular-contact ball bearing is not loaded by radial forces, in a further configuration of the invention, it is provided that the bearing bore diameter of the individual inner ring associated with the angular contact ball bearing is larger by a defined amount than the diameter of the associated shaft section.

In this connection it may also be provided, for example, that the external diameter of the individual outer ring associated with the angular contact ball bearing is smaller than the diameter of the associated section of the housing, forming a defined clearance A.

In order to ensure a radial displacement of the individual ring of the angular contact ball bearing for constraint-free centering thereof under load within the scope of the radial play of the cylindrical roller bearing, it is provided according to a further configuration that the difference or clearance A between the bearing bore diameter or the external diameter of the individual ring of the angular contact ball bearing and the associated section of the shaft or the hollow shaft is greater than or equal to twice the value of the radial play of the cylindrical roller bearing.

Precise axial positioning of the second individual ring with respect to the first individual ring is achieved by measuring this positioning after a first provisional installation of the second individual ring and by compensating any axial overdimensioning or underdimensioning of the second individual ring by removing material or by inserting a spacer ring.

The rolling bodies of the angular contact ball bearing and/or of the cylindrical roller bearing are preferably guided in a cage in order to prevent friction of the rolling bodies against one another.

In a bearing assembly according to the invention it may further be provided that an annular groove, into which a circlip is fitted, is formed radially on the outside of the end of the one-piece inner ring oriented away from the angular contact ball bearing. This circlip preferably acts as protection against disassembly, so that the bearing assembly can be produced and marketed by a bearing manufacturer as an installation-ready bearing unit. The circlip preferably maintains a clearance C from the adjacent cylindrical rollers of the cylindrical roller bearing such that the circlip and the cylindrical rollers do not touch.

Alternatively, the one-piece inner ring or outer ring of the cylindrical roller bearing may be provided on its end oriented away from the angular contact ball bearing with a washer disk which prevents this one-piece bearing ring from escaping from the bearing assembly. In the last-described design it may preferably be provided that both individual rings of the two-part inner ring are firmly connected, after installation of the cylindrical rolling bodies, by means of the clip as already described.

It is further considered advantageous if it is provided that the two individual rings each have in the region of their end faces oriented towards one another a radially outer axial groove into which is fitted a locking element which protects the two individual rings from rotation relative to one another. In a further configuration, the locking element may be in the form of a key which is bonded into the axial groove of one of the two individual rings and projects axially from the first-mentioned axial groove in order to engage in the associated axial groove of the other individual ring.

Finally, according to a further configuration, it may be provided that the individual ring of the angular contact ball bearing and/or the individual ring of the cylindrical roller bearing has on its end face oriented towards the respective other individual ring a radial groove in which lubricant can be received and conveyed.

### BRIEF DESCRIPTION OF THE DRAWINGS

The invention is explained in more detail below with reference to three embodiments and to the appended drawing, in which:

FIG. 1 shows a longitudinal section through a bearing assembly with an angular contact ball bearing and a cylindrical roller bearing in an O-arrangement, which supports a central shaft in a housing;

FIG. 2 shows a longitudinal section through a bearing assembly similar to FIG. 1 but in an X arrangement, which supports a central shaft in a housing; and

FIG. 3 shows a bearing assembly in an O-arrangement similar to FIG. 1, but with an inner ring which consists of two firmly connected individual rings, or of a ring and a flange washer which is to be braced axially.

### DETAILED DESCRIPTION OF THE DRAWING

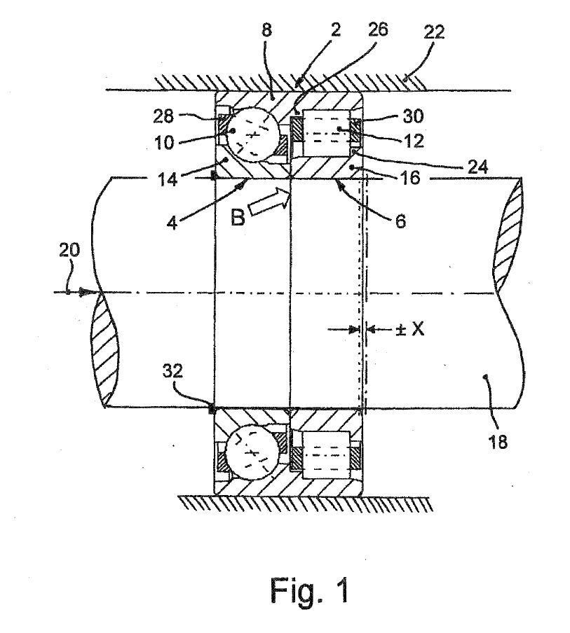

The bearing assembly 2 shown in FIG. 1 comprises an angular contact ball bearing 4 and a cylindrical roller bearing 6 coaxial therewith. Both bearings have a common one-piece outer ring 8, on the inner face of which are formed the tracks for the rolling bodies of these two bearings, that is, the balls 10 of the angular contact ball bearing 4 and the cylindrical rollers 12 of the cylindrical roller bearing 6. The inner bearing ring of the bearing assembly 2 is divided into a first individual ring 14 for the angular contact ball bearing 4 and a second individual ring 16 for the cylindrical roller bearing 6.

The bearing assembly 2 serves, for example, to guide a shaft 18 very precisely, radially and axially, in a housing 22, which shaft 18 must receive in operation a relatively large axial force in the direction of the arrow 20, and occasionally and for relatively short periods a smaller back-pressure force in the opposite direction. The main force exerted in operation is transmitted from the shaft 18 via the first individual ring 14, the bails 10 and the outer ring 8 to the housing 22. The outer ring 8 must therefore be fixed in the housing 22 against displacement in the direction of the arrow 20, while the first individual ring 14 is fixed against relative displacement on the shaft 18 oppositely to the direction of the arrow, so that the main force can be transmitted from the shaft 18 to the first individual ring 14.

The back-pressure force acting in a direction opposite to the arrow 20 is transmitted in a corresponding manner from the shaft 18 via the second individual ring 16, which is equipped with a rim 24 facing radially outwards, via the cylindrical rollers 12 and the outer ring 8, which is equipped with a rim 26 facing radially inwards, to the housing 22, so that the outer ring 8 must also be fixed in the housing 22 in the direction opposite to the arrow 20.

In order to isolate the angular contact ball bearing 4 from radial forces, the diameter of the shaft 18, at least in the region which receives the first individual ring 14, is smaller than the bore diameter of the individual ring 14. The axial fixing of the first individual ring 14 is therefore ensured, for example, by a circlip 32 fitted into a shaft groove.

To definitely ensure that the transmission of an axial force from one individual ring to the other individual ring is excluded, so that the main force exerted in operation on the one hand, and the opposite back-pressure force on the other, are in each case received only by the bearing 4 or 6 provided for that purpose, a small axial play is provided between the end faces oriented towards one another of the individual rings 14 and 16, that is, in the joint designated by B.

In order to achieve a precise axial position of the second individual ring 16 with respect to the first individual ring 14, after a first provisional installation of the second individual ring 16, the axial position of its outer end face is measured and any axial overdimensioning or underdimensioning ±X present is compensated by suitable removal of material or insertion of a spacer ring.

Cages for the balls 10 and the cylindrical rollers 12, which guide these rolling bodies and prevent friction thereof against one another, are designated by reference numerals 28 and 30 respectively.

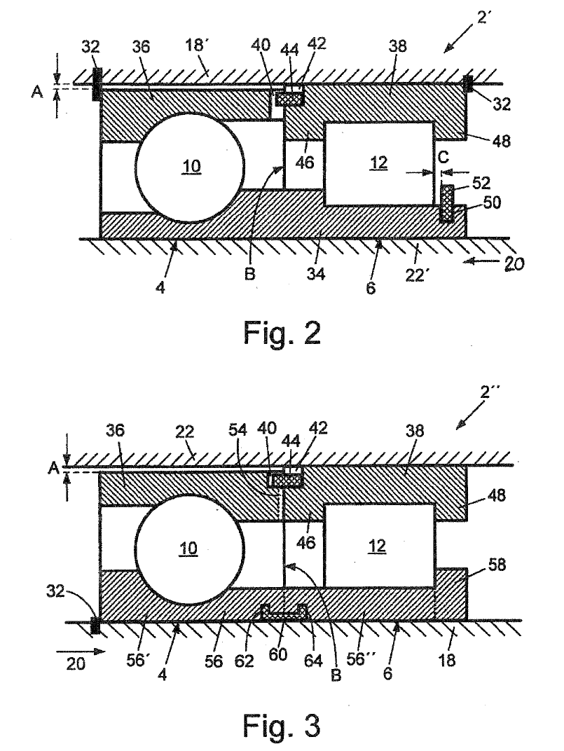

FIG. 2 shows a second exemplary embodiment of a bearing assembly 2′ according to the invention, in which the angular contact ball bearing 4 has an X arrangement and in which the bearing assembly 2′ supports a shaft 22′ in a housing 18′. In this design a one-piece inner ring 34 is used for the rolling bodies 10 and 12 of the angular contact ball bearing 4 and the cylindrical roller bearing 6, while the outer rings 36 and 38 are in the form of individual rings.

In addition, in order to prevent with a high degree of reliability a transmission of radial forces via the angular contact ball bearing, the outer circumferential face of the individual ring 36 of the angular contact ball bearing 4 has a clearance A from the inner cylindrical surface of the housing 18′, while the individual ring 38 of the cylindrical roller bearing 6 is connected non-positively to the inner cylindrical surface of the housing 18′.

The transmission of an axial force in the main load direction 20 from the shaft 22′ to the bearing assembly 2′ is effected, for example, by means of a shaft collar (not shown) on the side of the cylindrical roller bearing, which collar transmits said force to the one-piece inner ring.

In order to ensure that the two individual rings 36 and 38 do not rotate, or rotate only insignificantly, with respect to one another circumferentially, they have in the region of their opposite end faces respective axial grooves 40 and 42 into which is fitted a key 44 as a locking means.

FIG. 2 also shows that the individual ring 38 of the cylindrical roller bearing 6 has inwardly facing flanges 46 and 48 between which the cylindrical rolling bodies 12 are arranged. A circlip 52, which serves to prevent disassembly of the finished bearing assembly 2′, is fitted into an annular groove 50 in the region of the free axial end of the common inner ring 34. In this case the distance C of the circlip 52 from the adjacent cylindrical rollers 12 is selected such that they do not touch one another.

Comparatively small axial forces from the direction opposite to the main load direction 20 are transmitted from the shaft 22′ via suitable securing means (e.g. shaft nut, circlip, shaft collar, end cover, etc.) to the common inner ring 34′, via the cylindrical rollers 12, and finally via the rim 48 of the individual ring 38 to the housing 18′ (again via axial securing means or a housing collar, etc.).

A last variant is represented in FIG. 3, which shows a bearing assembly 2″ with an O-arrangement of the angular contact ball bearing 4. In this exemplary embodiment as well, the bearing assembly 2″ serves, as in FIG. 1, to support a central shaft 18 in a non-rotatable housing 22. The outer rings of the angular contact ball bearing 4 and of the cylindrical roller bearing 6 abut one another at the joint B and are in the form of individual rings 36, 38, of which the individual ring 38 of the cylindrical roller bearing 6 is received positively and non-positively in the housing 22, while the individual ring 36 of the angular contact ball bearing 4 has an external diameter such that a clearance A between the outer cylindrical surface of this individual ring 36 and the inner cylindrical surface of the housing 22 can be observed. This clearance A is sufficiently large to ensure, while taking account of the radial play of the cylindrical roller bearing 6, that no radial force is transmitted from the shaft 18 via the angular contact ball bearing 4 to the housing 22.

As in the exemplary embodiment shown in FIG. 2, it is also provided in the bearing assembly 2″ according to FIG. 3 that the two outer rings 36 and 38 are prevented from rotating with respect to one another. For this purpose they have in the region of their opposite end faces respective axial grooves 40 and 42 into which, for example, a key 44 is fitted as a locking means.

In addition, a radial groove denoted by reference 54, which can be used for regreasing, is formed in the inner end face of the individual ring 36 of the angular contact ball bearing 4.

The bearing assembly 2″ according to FIG. 3 is further distinguished by the fact that the radially inner bearing ring 56 consists of two individual rings 56′ and 56″ firmly connected to one another, which each have in the region of their end faces oriented towards one another respective annular grooves 62, 64 into which is fitted a clip 60, which connects the two individual rings 56′, 56″ firmly without axial play and with flush radially inner faces. Through this design both inner rings 56′ and 56″ can be produced and installed individually, and firmly connected to one another by means of the clip 60 only in a subsequent manufacturing step.

Finally, FIG. 3 shows that the two-part inner ring 56 (56′, 56″) is firmly connected to a washer disk 58 at its free end on the cylindrical roller side. This washer disk 58 serves, on the one hand, to prevent escape of the rollers and, on the other, to transmit axial forces which are conducted against the main load direction 20 from the shaft 18 into the bearing assembly 2″. These comparatively small axial forces are then transmitted via the cylindrical rollers 12 and the flange 46 of the radially outer individual ring 38 of the cylindrical roller bearing 6 to the housing 22.

In a further configuration of this design, the one-piece inner ring 56 (without the grooves 62, 64 and without the clip 60) can be implemented with a loose washer disk 58. In this case, an axial bracing of the one-piece inner ring 56 plus the loose washer disk 58 (for example with shaft nut and opposed shaft collar), is required during installation on the shaft.

### LIST OF REFERENCES

2 Bearing assembly
2′ Bearing assembly
2″ Bearing assembly
4 Angular contact ball bearing
6 Cylindrical roller bearing
8 Outer ring
10 Balls
12 Cylindrical rollers
14 First individual ring on angular contact ball bearing, radially inside
16 Second individual ring on cylindrical roller bearing, radially inside
18 Shaft
18′ Housing
20 Arrow (axial force), main load direction
22 Housing
22′ Shaft
24 Rim on individual ring
26 Rim on outer ring
28 Cage
30 Cage
32 Circlip
34 One-piece inner ring
36 First individual ring on angular contact ball bearing, radially outside
38 Second individual ring on cylindrical roller bearing, radially outside
40 Axial groove in individual ring 36
42 Axial groove in individual ring 38
44 Locking element
46 Rim on second individual ring 38
48 Rim on second individual ring 38
50 Annular groove in one-piece inner ring 34
52 Circlip in annular groove 50
54 Radial groove in axially inner end face of individual ring 36
56 Two-part inner ring
56′ First part of inner ring 56
56″ Second part of inner ring 56
58 Fixed washer disk on two-part inner ring 56″ or loose washer disk on one-piece inner ring 56
60 Clip
62 Annular groove in first part 56′ of inner ring 56
64 Annular groove in second part 56″ of inner ring 56
A Radial play
B Joint
C Axial clearance
±X Overdimensioning or underdimensioning

1. A bearing assembly for a shaft which is axially guided with precision on a housing and which is stressed to differing degrees and/or for different time periods, comprising:
an angular contact ball bearing arrangement designed substantially to receive axial forces; and
a cylindrical roller bearing arrangement designed substantially to receive radial forces,
wherein the angular contact ball bearing arrangement is a single-row angular contact ball bearing designed to receive a stronger axial force and the cylindrical roller bearing arrangement is a single-row cylindrical roller bearing conceived as a support bearing and designed to receive a weaker axial force and a radial force.

2. The bearing assembly as in claim 1, wherein, in each case, one of the bearing rings, namely an outer bearing ring or an inner bearing ring, is formed in one piece and is fixed in both axial directions with respect to an associated component, the associated component being a housing and shaft, wherein a respective other bearing ring is formed from two individual rings, each of the two individual rings being fixed with respect to the associated component in an axial direction corresponding to an axial force to be transmitted, a joint (joint B) being provided between the two individual rings for separate radial adjustment of the individual two rings with respect to one another, and play, absence of play or preload being able to be present in particular inside the joint.

3. The bearing assembly of claim 2, wherein the outer bearing ring is in one piece and the inner bearing ring consists of two individual rings.

4. The bearing assembly of claim 2, wherein the inner bearing ring is in one piece and the outer bearing ring consists of two individual rings.

5. The bearing assembly of claim 2, wherein the inner bearing ring consists of two individual rings firmly connected to one another or of a one-piece inner ring plus washer disk, and the two other bearing rings consists of individual rings.

6. The bearing assembly of claim 5, wherein the two individual rings each have, in a region of their end faces oriented towards one another, an annular groove into which is fitted a clip which firmly connects the two individual rings without axial play and with flush faces.

7. The bearing assembly of claim 2, wherein a bearing bore diameter of the individual ring associated with the angular contact ball bearing is larger than a diameter of an associated section of the shaft.

8. The bearing assembly of claim 2, wherein an external diameter of the individual ring associated with the angular contact ball bearing is smaller than a diameter of an associated section of the housing, forming a clearance.

9. The bearing assembly of claim 7, wherein a difference between the bearing bore diameter or an external diameter of the two individual ring of the angular contact ball bearing (4) and an associated section of the shaft or of the housing is greater than or equal to twice an radial play of the cylindrical roller bearing.

10. The bearing assembly of claim 2, wherein an axial overdimensioning or underdimensioning on an outer end face of a second individual ring remaining after precise axial positioning of the second individual ring with respect to a first individual ring is compensated by removal of material or by insertion of a spacer ring.

11. The bearing assembly of claim 1, wherein rolling bodies of the angular contact ball bearing and/or of the cylindrical roller bearing are guided in respective cages.

12. The bearing assembly of claim 4, wherein an annular groove into which a circlip is fitted is formed radially on an outside of an end of the inner bearing ring oriented away from the angular contact ball bearing.

13. The bearing assembly of claim 12, wherein the circlip, as protection against disassembly, maintains a clearance from cylindrical rollers of the cylindrical roller bearing such that they do not touch one another.

14. The bearing assembly claim 2, wherein a defined axial annular overhang, which makes possible a defined axial shaft position relative to the housing, is implemented on one side between the inner bearing ring and the outer bearing ring, on the angular contact ball bearing or on the cylindrical roller bearing.

15. The bearing assembly of 2, wherein the two individual rings each have radially on an outside an axial groove into which is fitted a locking element which protects the two individual rings against relative rotation with respect to one another.

16. The bearing assembly of claim 15, wherein the locking element a key.

17. The bearing assembly claim 2, wherein an individual ring of the angular contact ball bearing has on its end face oriented towards an individual ring of the cylindrical roller bearing at least one radial groove for conveying lubricant.
